(19) United States
(12) Patent Application Publication
(10) Pub. No.: US 2025/0159094 A1
(43) Pub. Date: May 15, 2025

(54) SERVICE PROVISION SYSTEM, INFORMATION PROCESSING DEVICE, AND PROGRAM

(71) Applicant: SEIKO EPSON CORPORATION, TOKYO (JP)

(72) Inventors: Yasuaki HIRAI, Shiojiri-shi (JP); Fumika MATSUZAKI, MATSUMOTO-SHI (JP); Masahiko HIRASAWA, YAMAGATA-MURA (JP); Satoshi NOGAITO, MATSUMOTO-SHI (JP); Yukimitsu FUJIMORI, MATSUMOTO-SHI (JP)

(21) Appl. No.: 18/947,006

(22) Filed: Nov. 14, 2024

(30) Foreign Application Priority Data
Nov. 14, 2023 (JP) 2023-193506

(51) Int. Cl. H04N 1/34; H04N 1/00

(52) U.S. Cl. CPC H04N 1/346; H04N 1/00408

(57) ABSTRACT

A service provision system provides a print service for which a charge is incurred in accordance with an area printed by a printing apparatus. The service provision system includes a conversion unit that converts an area printable by the printing apparatus without incurring an additional charge in the print service into the number of sheets of a first printing medium, and a display control unit that causes a terminal device to display the number of sheets of the first printing medium converted by the conversion unit.

The present application is based on, and claims priority from JP Application Serial Number 2023-193506, filed Nov. 14, 2023, the disclosure of which is hereby incorporated by reference herein in its entirety.

### BACKGROUND

### 1. Technical Field

The present disclosure relates to an information provision system, an information processing device, and a program.

### 2. Related Art

In related art, a technique of causing a charge to be incurred in accordance with an area is known. For example, JP-A-2016-151782 discloses a technique in which a charge is incurred in accordance with an area of a sheet manufactured by a sheet manufacturing apparatus. JP-A-2016-151782 discloses a charging mode in which when the area of the manufactured sheet is a predetermined area or less, the charge is fixed as a predetermined charge, and when the area of the manufactured sheet exceeds the predetermined area, a charge corresponding to the excess area is added to the predetermined charge.

However, when the charge is incurred in accordance with the area as in JP-A-2016-151782, even if an area usable without incurring an additional charge is presented to a user in terms of the area, the user may not easily understand the area usable without incurring the additional charge.

### SUMMARY

An aspect for solving the problem described above is a service provision system providing a print service for which a charge is incurred in accordance with an area printed by a printing apparatus. The service provision system includes a conversion unit configured to convert an area printable by the printing apparatus without incurring an additional charge in the print service into a number of sheets of a first printing medium, and a display control unit configured to cause a display unit to display the number of sheets of the first printing medium converted by the conversion unit.

Another aspect for solving the problem described above is an information processing device that includes a conversion unit configured to convert an area printable by a printing apparatus without incurring an additional charge in a print service into a number of sheets of a first printing medium, the print service for which a charge is incurred in accordance with an area printed by the printing apparatus, and a display control unit configured to cause a display unit to display the number of sheets of the first printing medium converted by the conversion unit.

Yet another aspect for solving the problem described above is a program that causes a processor of an information processing device to function as a conversion unit configured to convert an area printable by a printing apparatus without incurring an additional charge in a print service into a number of sheets of a first printing medium, the print service for which a charge is incurred in accordance with an area printed by the printing apparatus, and a display control unit configured to cause a display unit to display the number of sheets of the first printing medium converted by the conversion unit.

### BRIEF DESCRIPTION OF THE DRAWINGS

FIG. 1 is a diagram illustrating a configuration of a service provision system.

FIG. 2 is a block diagram illustrating an configuration of a terminal device.

FIG. 3 is a block diagram illustrating a configuration of a printing apparatus.

FIG. 4 is a block diagram illustrating a configuration of a provision server.

FIG. 5 illustrates flowcharts illustrating operations of the service provision system.

FIG. 6 is a flowchart illustrating an operation of a conversion unit during conversion processing.

### DESCRIPTION OF EMBODIMENTS

### 1. Configuration of Service Provision System

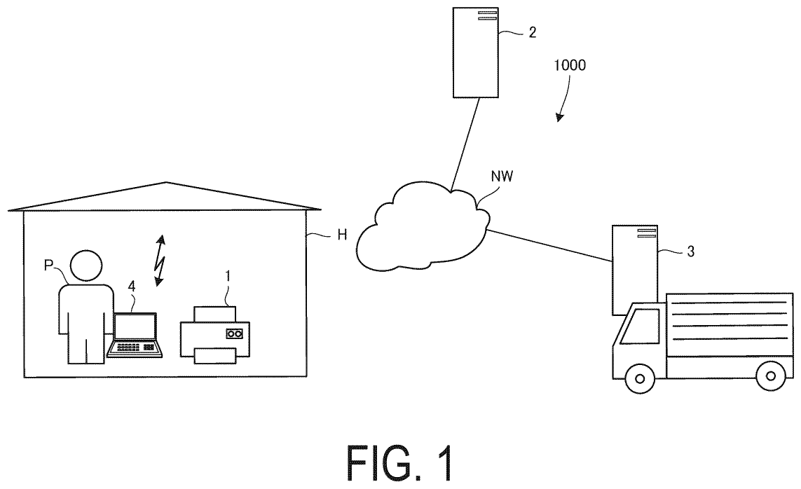

FIG. 1 is a diagram illustrating a configuration of a service provision system 1000.

The service provision system 1000 is a system that provides a print service that is usable when using a printing apparatus 1. The print service is a service related to printing of the printing apparatus 1. In this embodiment, the print service is a service for delivering consumables of the printing apparatus 1. The print service is a service in which a user of the print service pays a usage fee for use of the print service during a certain period of time, in other words, is a so-called subscription service. In the embodiment, a service in which the user of the print service pays a usage fee for use of the print service during one month will be exemplified. Further, in the embodiment, ink is used as an example of the consumables delivered in the print service.

The service provision system 1000 includes a provision server 2. The provision server 2 is a server device that manages the print service. The provision server 2 is connected to a network NW including the Internet, a telephone network, and other communication networks, and communicates with devices connected to the network NW. The provision server 2 is managed by, for example, a company that operates the print service. Note that although the provision server 2 is represented by one block in each drawing, this does not necessarily mean that the provision server 2 is constituted by a single server device. For example, the provision server 2 may include a plurality of server devices having different processing contents.

The provision server 2 is an example of an “information processing device”.

The service provision system 1000 includes a delivery server 3. The delivery server 3 is a server device that instructs a delivery worker to deliver a delivery item to a delivery destination H. The delivery server 3 is owned by, for example, a company to which a delivery operation is entrusted from the company that operates the print service, and sends a delivery instruction to the delivery worker who is an employee of the company entrusted with the delivery operation. The delivery server 3 is connected to the network NW and communicates with the devices connected to the network NW. In the embodiment, the delivery item whose delivery is instructed by the delivery server 3 is a container such as an ink cartridge containing ink.

Note that although the delivery server 3 is represented by one block in each drawing, this does not necessarily mean that the delivery server 3 is constituted by a single server device. For example, the delivery server 3 may be constituted by a plurality of server devices having different processing contents.

The service provision system 1000 includes the printing apparatus 1. The printing apparatus 1 is an inkjet printer, and performs printing by receiving supply of ink from an ink cartridge mounted on the printing apparatus 1. Note that the maximum number of colors of ink that can be ejected from an inkjet head of the printing apparatus 1 may be any number.

The service provision system 1000 includes a terminal device 4. The terminal device 4 is a computer used by a user P. In the embodiment, a laptop computer is exemplified as the terminal device 4, but the terminal device 4 may be a desktop computer or a portable computer such as a smartphone. The terminal device 4 is connected to the network NW and communicates with the provision server 2. The terminal device 4 also communicates with the printing apparatus 1. The communication between the terminal device 4 and the printing apparatus 1 may be communication via a local network established at the delivery destination H of the delivery item, or direct communication, such as Wi-Fi Direct, in which wireless communication is performed without using an access point. Wi-Fi is a registered trademark.

The terminal device 4 is an example of a “display unit”.

The user P is illustrated in FIG. 1. The user P is a person who has completed registration to use the print service.

In the print service provided by the service provision system 1000, an ink cartridge storing ink to be consumed by the printing apparatus 1 is delivered to the delivery destination H designated by the user P.

In the print service, a plan for using the print service is provided. This plan is a plan in which printing by the printing apparatus 1 can be performed on a certain area at a fixed charge during a certain period of time, and printing performed beyond the certain area is charged in accordance with the printed area. Hereinafter, the printing area printable within a range of the fixed charge will be referred to as a “printable area”.

### 2. Configuration of Terminal Device

Next, a configuration of the terminal device 4 will be described.

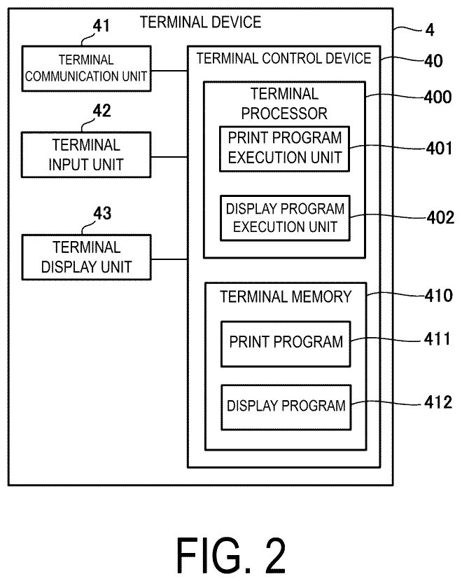

FIG. 2 is a block diagram illustrating the configuration of the terminal device 4.

The terminal device 4 includes a terminal control device 40, a terminal communication unit 41, a terminal input unit 42, and a terminal display unit 43.

The terminal communication unit 41 includes communication hardware, such as a communication circuit, conforming to a predetermined communication standard, and communicates with the provision server 2 and the printing apparatus 1 under the control of the terminal control device 40.

The terminal input unit 42 includes a keyboard, a mouse, and other input units, detects an operation of the user P on the input unit, and outputs the detected operation to the terminal control device 40. Based on the input from the terminal input unit 42, the terminal control device 40 executes processing corresponding to the operation of the user P with respect to the input unit.

The terminal display unit 43 includes a display, and displays various types of information on the display under the control of the terminal control device 40.

The terminal control device 40 includes a terminal processor 400 constituted by a central processing unit (CPU), a micro processing unit (MPU), or the like, and a terminal memory 410, and controls each unit of the terminal device 4.

The terminal memory 410 stores a program to be executed by the terminal processor 400 and various types of data to be processed by the terminal processor 400. The terminal memory 410 stores a print program 411, a display program 412, and other various types of data. The terminal memory 410 has a non-volatile storage area. The terminal memory 410 includes a volatile storage area and configures a work area of the terminal processor 400. The terminal memory 410 is constituted by, for example, a read only memory (ROM), a random access memory (RAM), or the like.

The print program 411 is a program that controls the printing apparatus 1 and transmits information related to the printing apparatus 1 to the provision server 2.

The display program 412 is a program that displays information received from the provision server 2.

By reading and executing the print program 411, the terminal processor 400 functions as a print program execution unit 401.

The print program execution unit 401 communicates with the provision server 2 and the printing apparatus 1 via the terminal communication unit 41. The print program execution unit 402 also generates print data and transmits the generated print data to the printing apparatus 1 via the terminal communication unit 41. The print data includes image data for a printing mode, a print command conforming to a command system of the printing apparatus 1, and the like.

By reading and executing the display program 411, the terminal processor 400 functions as a display program execution unit 402.

The display program execution unit 402 communicates with the provision server 2 via the terminal communication unit 41. The display program execution unit 402 also receives an instruction from the user P via the terminal input unit 42. Further, the display program execution unit 402 displays information using the terminal display unit 43.

### 3. Configuration of Printing Apparatus

Next, a configuration of the printing apparatus 1 will be described.

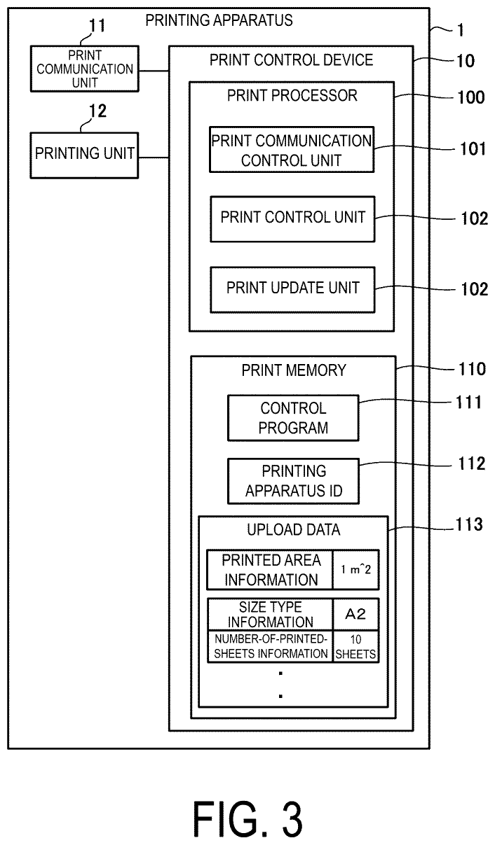

FIG. 3 is a block diagram illustrating the configuration of the printing apparatus 1.

The printing apparatus 1 includes a print control device 10, a print communication unit 11, and a printing unit 12.

The print communication unit 11 includes communication hardware, such as a communication circuit, conforming to a predetermined communication standard, and communicates with the terminal device 4 under the control of the print control device 10.

The printing unit 12 includes components related to printing such as an inkjet head, a carriage that moves the inkjet head in a scanning direction, a motor that drives the carriage, a transport mechanism that transports a printing medium, a mechanism on which an ink cartridge is mounted, and a maintenance mechanism for the inkjet head. The printing unit 12 performs printing on a printing medium under the control of the print control device 10.

The print control device 10 includes a print processor 100 constituted by a CPU, an MPU, or the like, and a print memory 110, and controls each unit of the printing apparatus 1.

The print memory 110 stores a program to be executed by the print processor 100 and data to be processed by the print processor 100. The print memory 110 stores a control program 111, a printing apparatus identification (ID) 112, upload data 113, and other various types of data. The print memory 110 has a non-volatile storage area. The print memory 110 includes a volatile storage area and configures a work area of the print processor 100. The print memory 110 is constituted by, for example, a ROM, a RAM, or the like.

The printing apparatus ID 112 is identification information for uniquely identifying the printing apparatus 1.

The upload data 113 is data to be uploaded to the provision server 2.

The upload data 113 includes printed area information. The printed area information is information indicating an area printed by the printing apparatus 1. More specifically, the area indicated by the printed area information indicates an area printed by the printing apparatus 1 during a period from a previous transmission of the upload data 113 to the provision server 2 to a subsequent transmission of the upload data 113 to the provision server 2.

The upload data 113 includes a pair of pieces of information, which are size type information indicating a type of the size of the printing medium, and number-of-printed-sheets information, for each size of the printing medium printable by the printing apparatus 1. For example, when the sizes of the printing medium printable by the printing apparatus 1 are A2, A3, and A4, the upload data 113 includes a pair of the size type information and the number-of-printed-sheets information related to the size A2, a pair of the size type information and the number-of-printed-sheets information related to the size A3, and a pair of the size type information and the number-of-printed-sheets information related to the size A4. The number-of-printed-sheets information is information indicating the number of printed sheets. More specifically, the number of printed sheets indicated by the number-of-printed-sheets information indicates the number of sheets printed by the printing apparatus 1 during the period from the previous transmission of the upload data 113 to the provision server 2 to the subsequent transmission of the upload data 113 to the provision server 2.

The print processor 100 functions as a print communication control unit 101, a print control unit 102, and a print update unit 103 by reading and executing the control program 111.

The print communication control unit 101 communicates with the terminal device 4 via the print communication unit 11. The print communication control unit 101 of the embodiment receives print data from the terminal device 4. Further, the print communication control unit 101 according to the embodiment transmits, to the terminal device 4, the upload data 113 to which the printing apparatus ID 112 is added. Note that the print program execution unit 401 of the terminal device 4 transfers, to the provision server 2, the upload data 113 received from the printing apparatus 1. The printing apparatus ID 112 is added to the upload data 113 to be transferred to the provision server 2.

The print control unit 102 causes the printing unit 12 to perform printing based on the print data received by the print communication control unit 101.

The print update unit 103 updates the content indicated by each piece of the information included in the upload data 113. The print update unit 103 updates the area indicated by the printed area information. The print update unit 103 refers to the print data processed by the print control unit 102 to calculate the area printed by the print control unit 102. For example, when the area to which ink has been ejected is recorded in the print data for each sheet of the printing medium, the print update unit 103 calculates, as the area printed by the print control unit 102, the sum of the areas, recorded in the print data, onto which the ink has been ejected. When the print control unit 102 calculates the printed area, the print update unit 103 updates the area indicated by the printed area information to an area obtained by adding the calculated area to the area indicated by the printed area information.

The print update unit 103 also updates the number of printed sheets indicated by the number-of-printed-sheets information. The print update unit 103 refers to the print data processed by the print control unit 102 to acquire, for each size of the printing medium, the number of sheets printed by the print control unit 102. For example, when information indicating that three sheets of the size A4 have been printed is recorded in the print data processed by the print control unit 102, the print update unit 103 acquires three as the number of sheets printed by the print control unit 102, with respect to the size A4 of the printing medium. When the number of sheets printed by the print control unit 102 is acquired for each size of the printing medium, the print update unit 103 updates the number of printed sheets indicated by the number-of-printed-sheets information of the corresponding size, to the number of sheets obtained by adding the acquired number of sheets to the number of printed sheets indicated by the number-of-printed-sheets information.

Further, when the print communication control unit 101 transmits the upload data 113, the print update unit 103 updates the content indicated by each piece of the information of the upload data 113 stored in the print memory 110 to 0. That is, the print update unit 103 updates the area indicated by the printed area information to 0, and updates the number of printed sheets indicated by the number-of-printed-sheets information to 0.

### 4. Configuration of Provision Server

Next, a configuration of the provision server 2 will be described.

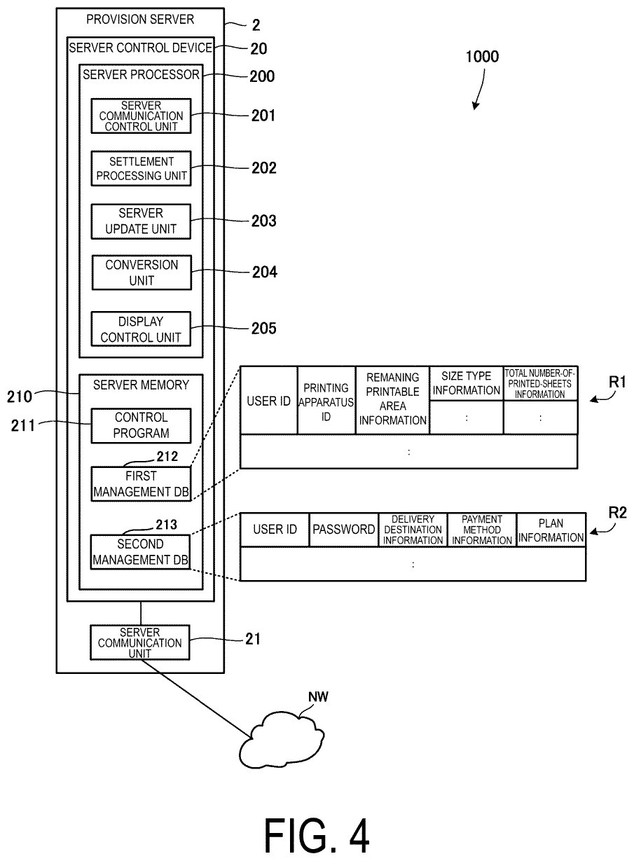

FIG. 4 is a block diagram illustrating the configuration of the provision server 2.

The provision server 2 includes a server control device 20 and a server communication unit 21.

The server communication unit 21 includes communication hardware conforming to a predetermined communication standard, and communicates with the devices connected to the network NW under the control of the server control device 20.

The server control device 20 includes a server processor 200 constituted by a CPU, an MPU, or the like, and a server memory 210, and controls each unit of the provision server 2 by the server processor 200 executing a program stored in the server memory 210.

The server processor 200 is an example of a “processor”.

The sever memory 210 stores the program to be executed by the server processor 200 and data to be processed by the server processor 200. The server memory 210 stores a control program 211 executed by the server processor 200, a first management DB 212, a second management DB 213, and other various types of data. The server memory 210 has a non-volatile storage area. The server memory 210 includes a volatile storage area and configures a work area of the server processor 200. The server memory 210 is constituted by, for example, a ROM, a RAM, or the like.

The control program 211 is an example of a “program”.

The first management DB 212 is a database that manages one record R1 for each of the users P.

The one record R1 includes a user identification (ID), the printing apparatus ID, and remaining printable area information. The user ID is identification information for uniquely identifying the user P. The remaining printable area information is information indicating a remaining printable area. The remaining printable area is a remaining area printable within the range of the fixed charge. The record R1 indicates the size type information and total number-of-printed-sheets information for each size of the printing medium printable by the printing apparatus 1, for each of the printing apparatus IDs 112. The total number of printed sheets indicated by the total number-of-printed-sheets information is the total number of printed sheets during one month.

The second management DB 213 is a database that manages one record R2 for each of the users P.

The one record R2 includes the user ID, a password, delivery destination information, payment method information, and plan information. The password is authentication information for authenticating the user of the print service. The delivery destination information is information indicating the delivery destination H, and is, for example, an address. The payment method information is information indicating a payment method for paying the usage fee of the print service. For example, when the payment method information indicates a payment method using a credit card, the payment method information includes a combination of information indicating that the payment method is the credit card, and a credit card number. The plan information is information indicating a plan of the print service contracted by the user P, and at least the usage fee and the printable area are recorded in the plan information.

By reading and executing the control program 211, the server processor 200 functions as a server communication control unit 201, a settlement processing unit 202, a server update unit 203, a conversion unit 204, and a display control unit 205.

The server communication control unit 201 communicates with the terminal device 4 via the server communication unit 21.

The settlement processing unit 202 performs settlement processing on the one record R2, which is the object to be processed, of the second management DB 213. The settlement processing unit 202 performs the settlement processing based on the usage fee indicated by the plan information, using the payment method indicated by the payment method information. When the settlement processing is normally completed, the settlement processing unit 202 transmits, to the server update unit 203, the user ID and the plan information included in the processed record R2.

The server update unit 203 updates the contents of the databases stored in the server memory 210. The server update unit 203 according to the embodiment updates the content of the record R1 managed by the first management DB 212.

When the user ID and the plan information are received from the settlement processing unit 202, the server update unit 203 identifies, in the first management DB 212, the record R1 including the received user ID. Subsequently, the server update unit 203 updates the remaining printable area indicated by the remaining printable area information of the identified record R1, to the printable area indicated by the received plan information.

Further, when the server communication control unit 201 receives the upload data 113, the server update unit 203 updates the remaining printable area information and the total number-of-printed-sheets information, based on the received upload data 113.

More specifically, the server update unit 203 identifies, in the first management DB 212, the record R1 including the printing apparatus ID that has been added to the upload data 113. Subsequently, the server update unit 203 updates the remaining printable area indicated by the remaining printable area information of the identified record R1, to a value obtained by subtracting the area indicated by the printed area information of the upload data 113 from the remaining printable area indicated by the remaining printable area information. Further, the server update unit 203 updates, for each piece of the size type information included in the upload data 113, the total number of printed sheets indicated by the total number-of-printed-sheets information of the identified record R1, to a number of printed sheets obtained by adding the number of printed sheets indicated by the number-of-printed-sheets information of the upload data 113 to the total number of printed sheets indicated by the total number-of-printed-sheets information.

The conversion unit 204 converts the remaining printable area into the number of sheets of the printing medium. The conversion unit 204 will be described later.

The display control unit 205 causes the terminal device 4 to display a number of remaining printable sheets. The number of remaining printable sheets is a number of remaining sheets of the printing medium printable within the range of the fixed charge. The display control unit 205 generates screen data for displaying the number of remaining printable sheets, and causes the server communication control unit 201 to transmit image data to the terminal device 4, thereby causing the terminal device 4 to display the number of remaining printable sheets.

### 5. Operation of Each Unit of Service Provision System

Next, each unit of the service provision system 1000 will be described.

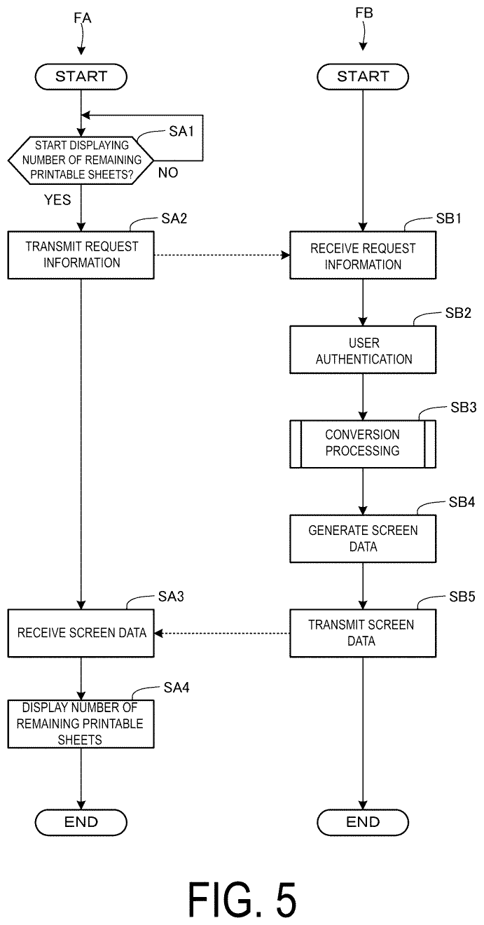

FIG. 5 illustrates flowcharts illustrating operations of the service provision system 1000. In FIG. 5, a flowchart FA illustrates an operation of the terminal device 4, and a flowchart FB illustrates an operation of the provision server 2.

As illustrated in the flowchart FA, the display program execution unit 402 determines whether or not to display the number of remaining printable sheets (step SA1). When the display program execution unit 402 receives a display start instruction for the number of remaining printable sheets, the display program execution unit 402 makes a positive determination at step SA1.

When the display program execution unit 402 determines to display the number of remaining printable sheets (step SA1), the display program execution unit 402 transmits request information to the provision server 2 (step SA2). The request information is information for requesting screen data for displaying the number of remaining printable sheets, and includes the user ID and the password. The user ID and the password included in the request information are the user ID and the password received by the display program execution unit 402 from the user P, when the user P inputs the display start instruction for the number of remaining printable sheets.

As illustrated in the flowchart FB, the server communication control unit 201 receives the request information from the terminal 4 device (step SB1), and performs user authentication based on the user ID and the password included in the request information (step SB2). In the user authentication at step SB2, the server communication control unit 201 determines whether or not the second management DB 213 manages the record R2 containing a set of the user ID and the password included in the request information, and when it is determined that the second management DB 213 manages the record R2, the server communication control unit 201 determines that the authentication has been successful.

When it is determined at step SB2 that the authentication has been successful, the conversion unit 204 performs conversion processing (step SB3).

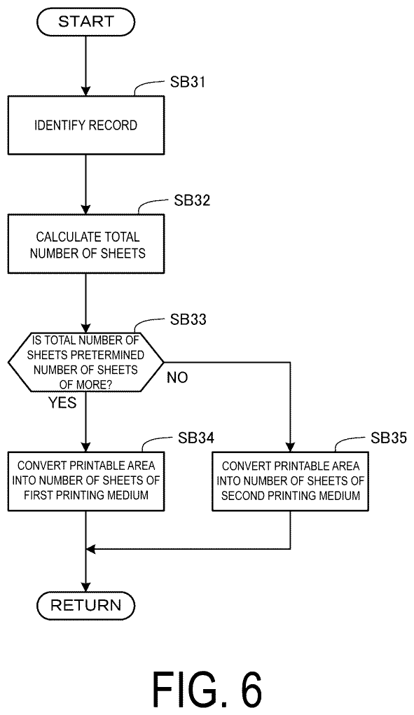

FIG. 6 is a flowchart illustrating an operation of the conversion unit 204 during the conversion processing.

The conversion unit 204 identifies, in the first management DB 212, the record R1 containing the user ID included in the request information received at step SA1 (step SB31).

Subsequently, the conversion unit 204 calculates the total number of printed sheets recorded in the identified record R1 (step SB32).

For example, it is assumed that, in the identified record R1, the total number-of-printed-sheets information corresponding to the size type information of the size A2 indicates 100 sheets, the total number-of-printed-sheets information corresponding to the size type information of the size A3 indicates 0 sheets, and the total number-of-printed-sheets information corresponding to the size type information of the size A4 indicates 10 sheets. In this example, the total number of sheets calculated by the conversion unit 204 is 110.

Subsequently, the conversion unit 204 determines whether or not the total number of sheets calculated at step SB32 is a predetermined number of sheets or more (step SB33). The predetermined number of sheets is 100, for example. Note that 100 is merely an example, and the predetermined number of sheets, which is used as a value to be compared at step SB23, may be less than 100 or more than 100.

When it is determined that the total number of sheets calculated at step SB22 is the predetermined number of sheets or more (step SB33: YES), the conversion unit 204 converts the remaining printable area of the identified record R1 into the number of sheets of a first printing medium (step SB34).

Step SB34 will be described in detail below.

In the embodiment, the first printing medium corresponds to a medium compatible with the printing apparatus 1 and used by the user P in the past. Specifically, in the embodiment, the first printing medium is a printing medium on which the printing apparatus 1 has performed printing most frequently. More specifically, in the embodiment, the first printing medium is a printing medium of a size on which the printing apparatus 1 has performed printing most frequently.

For example, it is assumed that, in the record R1 identified at step SB31, the total number-of-printed-sheets information corresponding to the size type information of the size A2 indicates 10 sheets, the total number-of-printed-sheets information corresponding to the size type information of the size A3 indicates 100 sheets, and the total number-of-printed-sheets information corresponding to the size type information of the size A4 indicates 25 sheets. In this example, the first printing medium is the printing medium of the size A3. Note that, in this example, the size A3 corresponds to an example of a “predetermined size”.

At step SB34, the conversion unit 204 determines the size of the first printing medium based on the total number-of-printed-sheets information of the identified record R1. Subsequently, the conversion unit 204 acquires the area of the identified first printing medium. For example, when data indicating the area of the printing medium for each size is stored in the server memory 210, the conversion unit 204 acquires the area of the identified first printing medium by reading the data from the server memory 210. Note that the area of the first printing medium acquired by the conversion unit 204 is an area of one side of the first printing medium, Then, the conversion unit 204 converts the remaining printable area of the identified record R1 into the number of sheets of the first printing medium, by dividing the remaining printable area of the identified record R1 by the acquired area of the first printing medium.

Returning to the description of step SB33, when it is determined that the total number of sheets calculated at step SB32 is less than the predetermined number of sheets (step SB33: NO), the conversion unit 204 converts the remaining printable area of the identified record R1 into the number of sheets of a second printing medium (step SB35).

For example, the second printing medium is a printing medium of a predetermined size, such as a printing medium of the size A4. Further, for example, the second printing medium is a printing medium having the maximum size among the printing media printable by the printing apparatus 1. Note that the size type of the second printing medium may vary depending on the geographical region or the country in which the printing apparatus 1 is used.

At step SB34, the conversion unit 204 acquires the area of the second printing medium. For example, when data indicating the area of the second printing medium is stored in the server memory 210, the conversion unit 204 acquires the area of the identified second printing medium by reading the data from the server memory 210. Note that the area of the second printing medium acquired by the conversion unit 204 is an area of one side of the second printing medium. Then, the conversion unit 204 converts the remaining printable area of the identified record R1 into the number of sheets of the second printing medium, by dividing the remaining printable area of the identified record R1 by the acquired area of the second printing medium.

Returning to the description of FIG. 5, when the conversion unit 204 performs the conversion processing, the display control unit 205 generates the screen data (step SB4).

The screen data generated at step SB4 displays the number of sheets converted by the conversion processing at step SB3, as the number of remaining printable sheets. Further, a screen represented by the screen data generated at step SB4 is a screen that displays the size of the printing medium, which has been used for the conversion in the conversion processing at step SB3. For example, the screen represented by the screen data generated at step SB4 displays a character string such as “The remaining printable amount is 6.2 sheets of the size A3”. Note that, as described above, in the conversion processing, the conversion is performed based on the area of one side of the printing medium. Therefore, for example, the screen represented by the screen data generated at step SB4 may be configured to display the number of remaining printable sheets in a case in which a single-sided printing mode is adopted. In this case, a character string is displayed such as “The remaining printable amount is 6.2 sheets of the size A3 in the single-sided printing mode”.

The server communication control unit 201 transmits, to the terminal device 4, the screen data generated at step SB4 as a response to the request information received at step SB4 (step SB5).

As illustrated in the flowchart FA, the display program execution unit 402 receives the screen data from the provision server 2 (step SA3).

Subsequently, the display program execution unit 402 displays the screen represented by the screen data received at step SA3 (step SA4).

As described above, in the service provision system 1000, the remaining printable area is displayed in terms of the number of sheets of the first printing medium or the second printing medium. For example, when the printing apparatus 1 can print the printing medium of the sizes A2, A3, and A4 and the size of the printing medium printed most frequently by the printing apparatus 1 is the size A3, in the service provision system 1000, the remaining printable area is displayed in terms of the number of sheets of the printing medium of the size A3. That is, in the service provision system 1000, when the most frequently printed printing medium has a size other than the maximum size among the printing media printable by the printing apparatus 1, the remaining printable area is displayed in terms of the number of sheets of the printing medium having the size other than the maximum size. Thus, the user P of the printing apparatus 1 can understand the remaining printable area in terms of the number of sheets of the printing medium having a desired size that is frequently used.

### 6. Other Embodiments

The embodiment described above merely represents one aspect of the present disclosure, and any modification and application of the embodiment is possible.

In the embodiment described above, the print service is the service for delivering the ink container used in the printing apparatus 1. In another embodiment, the print service may be a service for delivering consumables of the printing apparatus 1 other than the ink. Note that examples of the consumables of the printing apparatus 1 other than the ink include sheets of paper and a waste ink liquid box. Further, when the printing apparatus 1 is an electrophotographic printer, a toner container may be delivered in the print service.

In the embodiment described above, the print service is the service for delivering the consumables of the printing apparatus 1, but the print service is not limited to the service for delivering the consumables of the printing apparatus 1. For example, the print service may be a service that remotely monitors the printing amount of the printing apparatus 1, and that dispatches a maintenance operator for the printing apparatus 1 as necessary.

In the embodiment described above, the first printing medium is the printing medium on which the printing apparatus 1 has performed printing most frequently, but the first printing medium may be a printing medium of a size designated by the user P. In this case, the server memory 210 stores the size of the printing medium designated by the user P for each of the users P or for each of the printing apparatuses 1. Further, in this case, the conversion unit 204 may be configured to determine, in the conversion processing, whether or not the user P has designated a size of the printing medium instead of performing step SB33, and to perform step SB34 when a positive determination is made and perform step SB35 when a negative determination is made.

In the embodiment described above, a configuration is adopted in which the number of remaining sheets printable within the range of the fixed charge is displayed. In another embodiment, a configuration may be adopted in which the area printable by the printing apparatus 1 until the next charge is incurred may be displayed as the number of sheets. For example, a configuration may be adopted when a charge exceeding the range of the fixed charge is incurred by X yen per a square meter, the area printable by the printing apparatus 1 until X yen is charged next may be displayed by the number of sheets.

In the embodiment described above, the printing apparatus 1 to which an ink cartridge is mounted is exemplified as a “printing apparatus”. Here, the “printing apparatus” is a printing apparatus having a continuous ink supply system (CISS) in which an ink tank, which supplies ink to an inkjet head, can be refilled after use. In this case, in the print service, an ink bottle filled with ink is delivered to the delivery destination H.

In another embodiment, the display program execution unit 402 may function as the conversion unit 204 and the display control unit 205. In this configuration, the conversion unit 204 receives, from the provision server 2, the record R1 to be processed, and performs addition processing based on the received record R1. Further, when this configuration is adopted, the display control unit 205 generates screen data based on the conversion processing performed by the conversion unit 204, and causes the terminal display unit 43 to display a screen represented by the generated screen data.

In this another embodiment, the terminal device 4 corresponds to the “information processing device”, the terminal processor 400 corresponds to the “processor”, the display program 412 corresponds to the “program”, and the terminal display unit 43 corresponds to the “display unit”.

The printing apparatus 1 described above may be a multifunction peripheral having a scanning function and a facsimile function in addition to the printing function.

The printing apparatus 1 described above may be a serial-type inkjet printer, a line-type inkjet printer, or a lateral-type inkjet printer.

In another embodiment, functions of the server processor 200 and the terminal processor 400 may be implemented by a plurality of processors or a semiconductor chip.

Each unit of the terminal device 4, the printing apparatus 1, and the provision server 2 illustrated in FIGS. 2, 3, and 4 is merely an example, and is not particularly limited. In other words, hardware individually corresponding to each of the units need not necessarily be provided, and, as a matter of course, a configuration may be adopted in which a single processor executes a program to realize the function of each of the units. Some of the functions implemented by software may be implemented by hardware, or some of the functions implemented by hardware may be implemented by software. In addition, specific detailed configurations of other parts of the printing apparatus 1 and the provision server 2 may be modified as desired.

The steps of the operation illustrated in FIGS. 5 and 6 are divided according to main processing contents in order to facilitate understanding of the operations of the terminal device 4 and the provision server 2, and are not limited by the way of division of the processing and the name thereof. The processing may be divided into more steps according to the processing contents. One step may be divided so as to include more processing. Further, the order of the steps may be changed as appropriate.

### 7. Overview of Present Disclosure

An overview of the present disclosure is added below.

### Supplementary Note 1

A service provision system provides a print service for which a charge is incurred in accordance with an area printed by a printing apparatus. The service provision system includes a conversion unit configured to convert an area printable by the printing apparatus without incurring an additional charge in the print service into a number of sheets of a first printing medium, and a display control unit configured to cause a display unit to display the number of sheets of the first printing medium converted by the conversion unit.

According to this configuration, the area printable by the printing apparatus without incurring the additional charge for the print service is displayed in terms of the number of sheets. That is, the area printable by the printing apparatus is displayed in a unit with which it is easy for a user of the printing apparatus to understand the printable amount. Thus, the user of the printing apparatus can easily understand the amount printable without incurring the additional charge for the print service.

### Supplementary Note 2

In the service provision system described in Supplementary Note 1, the first printing medium is a printing medium compatible with the printing apparatus and used by a user of the printing apparatus in the past.

According to this configuration, the conversion can be performed using a printing medium for which the user of the printing apparatus is highly likely to know approximately how large the unit area of the printing medium is. Thus, the user of the printing apparatus can more easily understand the amount printable without incurring the additional charge for the print service.

### Supplementary Note 3

In the service provision system described in Supplementary Note 2, the first printing medium is a printing medium printed most frequently by the printing apparatus.

According to this configuration, it is possible to perform the conversion using the printing medium for which the user of the printing apparatus is highly likely to know approximately how large the unit area of the printing medium is. Thus, the user of the printing apparatus can more easily understand the amount printable without incurring the additional charge for the print service.

### Supplementary Note 4

In the service provision system described in Supplementary Note 3, when a number of sheets printed by the printing apparatus is a predetermined number of sheets or more, the conversion unit converts the area printable by the printing apparatus without incurring the additional charge for the print service into the number of sheets of the first printing medium.

According to this configuration, the conversion can be performed using a printing medium that is highly likely to be normally used by the user of the printing apparatus. Thus, the user of the printing apparatus can more easily understand the amount printable without incurring the additional charge for the print service.

### Supplementary Note 5

In the service provision system described in Supplementary Note 4, when the number of sheets printed by the printing apparatus is less than the predetermined number of sheets, the conversion unit converts the area printable by the printing apparatus without incurring the additional charge for the print service into a number of sheets of a second printing medium, and the display control unit displays the number of sheets of the second printing medium converted by the conversion unit.

According to this configuration, even when the number of sheets of the printing medium printed by the printing apparatus is less than the predetermined number of sheets, the area printable by the printing apparatus without incurring the additional charge for the print service can be displayed in terms of the number of sheets. Thus, even when the number of sheets of the printing medium printed by the printing apparatus is less than the predetermined number of sheets, the user of the printing apparatus can easily understand the amount printable without incurring the additional charge for the print service.

### Supplementary Note 6

In the service provision system described in Supplementary Note 3, when the printing medium printed most frequently by the printing apparatus is a printing medium of a predetermined size, the first printing medium is the printing medium of the predetermined size, and the predetermined size is a size other than a maximum size among the printing media printable by the printing apparatus.

According to this configuration, even when the most frequently printed printing medium is the size other than the maximum size, among the printing media printable by the printing apparatus, the conversion can be performed by the printing medium of this size. Thus, even when the user of the printing apparatus uses, in the printing apparatus, the size other than the maximum size among the printing media printable by the printing apparatus, the area printable by the printing apparatus without incurring the additional charge for the print service can be displayed in terms of the number of sheets.

### Supplementary Note 7

An information processing device includes a conversion unit configured to convert an area printable by a printing apparatus without incurring an additional charge in a print service into a number of sheets of a first printing medium, the print service for which a charge is incurred in accordance with an area printed by the printing apparatus, and a display control unit configured to cause a display unit to display the number of sheets of the first printing medium converted by the conversion unit.

According to this configuration, the same effect as that of the service provision system described in Supplementary Note 1 can be achieved.

### Supplementary Note 8

A program causes a processor of an information processing device to function as a conversion unit configured to convert an area printable by a printing apparatus without incurring an additional charge in a print service into a number of sheets of a first printing medium, the print service for which a charge is incurred in accordance with an area printed by the printing apparatus, and a display control unit configured to cause a display unit to display the number of sheets of the first printing medium converted by the conversion unit.

According to this configuration, the same effect as that of the service provision system described in Supplementary Note 1 can be achieved.

What is claimed is:

1. A service provision system providing a print service for which a charge is incurred in accordance with an area printed by a printing apparatus, the service provision system comprising:
a conversion unit configured to convert an area printable by the printing apparatus without incurring an additional charge in the print service into a number of sheets of a first printing medium; and
a display control unit configured to cause a display unit to display the number of sheets of the first printing medium converted by the conversion unit.

2. The service provision system according to claim 1, wherein
the first printing medium is a printing medium compatible with the printing apparatus and used by a user of the printing apparatus in the past.

3. The service provision system according to claim 2, wherein
the first printing medium is a printing medium printed most frequently by the printing apparatus.

4. The service provision system according to claim 3, wherein
when a number of sheets printed by the printing apparatus is a predetermined number of sheets or more, the conversion unit converts the area printable by the printing apparatus without incurring the additional charge for the print service into the number of sheets of the first printing medium.

5. The service provision system according to claim 4, wherein
when the number of sheets printed by the printing apparatus is less than the predetermined number of sheets, the conversion unit converts the area printable by the printing apparatus without incurring the additional charge for the print service into a number of sheets of a second printing medium, and
the display control unit displays the number of sheets of the second printing medium converted by the conversion unit.

6. The service provision system according to claim 3, wherein
when the printing medium printed most frequently by the printing apparatus is a printing medium of a predetermined size, the first printing medium is the printing medium of the predetermined size, and
the predetermined size is a size other than a maximum size, among the printing media printable by the printing apparatus.

7. An information processing device comprising:
a conversion unit configured to convert an area printable by a printing apparatus without incurring an additional charge in a print service into a number of sheets of a first printing medium, the print service for which a charge is incurred in accordance with an area printed by the printing apparatus; and
a display control unit configured to cause a display unit to display the number of sheets of the first printing medium converted by the conversion unit.

8. A program causing a processor of an information processing device to function as
a conversion unit configured to convert an area printable by a printing apparatus without incurring an additional charge in a print service into a number of sheets of a first printing medium, the print service for which a charge is incurred in accordance with an area printed by the printing apparatus, and
a display control unit configured to cause a display unit to display the number of sheets of the first printing medium converted by the conversion unit.
